(19) United States
(12) Patent Application Publication
(10) Pub. No.: US 2006/0127073 A1
(43) Pub. Date: Jun. 15, 2006

(54) Camera shake compensation mechanism and optical apparatus using the camera shake compensation mechanism

(75) Inventor: Koji Yasuda, Osaka (JP)

Correspondence Address: BRINKS HOFER GILSON & LIONE, P.O. BOX 10395, CHICAGO, IL, 60610, US

(73) Assignee: KONICA MINOLTA PHOTO IMAGING, INC.

(21) Appl. No.: 11/295,766

(22) Filed: Dec. 7, 2005

(30) Foreign Application Priority Data
Dec. 9, 2004 (JP) 2004-356563

(51) Int. Cl. G03B 17/00

(52) U.S. Cl. 396/55

(57) ABSTRACT

The optical apparatus of the present invention comprises: a body; a lens barrel provided in the body; a camera shake compensation mechanism that swings the lens barrel about two different rotation axes; and a connection portion for connecting the body and the lens barrel which connection portion is partly fixed to the lens barrel and disposed along the point of intersection of the two rotation axes of the lens barrel or an area formed in the vicinity thereof. By this, the amount of flection of the connection portion can be reduced so that the space for absorbing the flection can be extremely small, and further, the stress imposed on the connection portion can be made extremely small. Consequently, an optical apparatus having a small-size and highly reliable camera shake compensation mechanism is obtained.

This application is based on Japanese Patent Application No. 2004-356563 filed in Japan on 9 Dec. 2004, the entire content of which is hereby incorporated by reference.

### FIELD OF THE INVENTION

The present invention relates to a camera shake compensation mechanism and an optical apparatus using the camera shake compensation mechanism. More specifically, the present invention relates to a camera shake compensation mechanism having camera shake compensating means for performing camera shake compensation by swinging the lens barrel, and an optical apparatus using the camera shake compensation mechanism.

### DESCRIPTION OF RELATED ART

In optical apparatuses such as digital cameras, various camera shake compensation mechanisms are adopted in order to suppress the disturbance of a taken image due to a shake of the user's hand.

Conventionally, as such camera shake compensation mechanisms, the following have been put to practical use: a method in which a camera shake compensation lens is shifted within a plane vertical to the optical axis in a direction that cancels out the shake applied to the camera (Japanese Laid-Open Patent Application No. 2003-330055); and a method in which the image sensor itself is shifted within the plane vertical to the optical axis with no lens in the lens barrel being driven (United States Patent Application Publication No. US2003/0067544).

Moreover, a method has also been put to practical use in which the lens barrel is rotatably held by use of a so-called gimbal mechanism and the optical system including the lens barrel is swung to thereby perform camera shake compensation (Japanese Laid-Open Patent Application No. H07-274056).

In recent years, in cameras having such a camera shake compensation mechanism, size reduction of the cameras themselves is also required, and to realize both the camera shake compensation mechanism and the size reduction, it is necessary to give consideration also to an internal wiring portion that connects the camera shake compensation mechanism portion which is a movable portion and various boards used in the camera body.

As mounting methods to interconnect boards at least one of which is moved, the following have been put to practical use: a method in which a flexible wiring board that connects the lens units moved in the direction of the optical axis and a lens barrel fixing portion is bent rearward in the direction of the optical axis in the middle of the connection to the lens units to thereby remove flection (Japanese Laid-Open Patent Application No. 2004-205610); and a method in which the flexible wiring board is bent in the direction of the optical axis to thereby remove flection (Japanese Laid-Open Patent Applications Nos. 07-218803 and 2003-149528).

Moreover, in digital cameras provided with a rotation mechanism that rotates the lens barrel, a method has been put to practical use in which a wire rod that connects the lens barrel and the boards in the camera body is mounted inside the rotation shaft.

However, the above-mentioned patents are applicable when the members are moved in one direction (the direction of the optical axis), and are not applicable when the members are necessarily moved in two directions (the pitching and yawing directions orthogonal to the optical axis) like when camera shake compensation is performed.

Moreover, in the case of digital cameras provided with a rotation mechanism that rotates the lens barrel, the patents are applicable only when the members are rotated in one direction (the pitching direction orthogonal to the optical axis).

As a mounting method in the case of camera shake compensation, Japanese Laid-Open Patent Application No. 2003-330055 proposes to connect camera shake compensation lens moving means and position detecting means by a flexible board. However, this method is applicable to a camera shake compensation method using a camera shake compensation lens with a small movement amount, and is unsuitable for a camera shake compensation method in which a lens barrel with a large movement amount is swung because it is difficult to mount it in a small size.

### SUMMARY OF THE INVENTION

An object of the present invention is to provide a small-size optical apparatus having a camera shake compensation function by appropriately connecting non-swung members and the camera body in an optical apparatus that performs camera shake compensation by swinging the lens barrel.

The above-mentioned object is attained by providing the following structure:

An optical apparatus of the present invention comprises: a body; a lens barrel provided in the body; a camera shake compensation mechanism that swings the lens barrel about two different rotation axes; and a connection portion for connecting the body and the lens barrel which is partly fixed to the lens barrel and disposed along the point of intersection of the two rotation axes of the lens barrel or an area formed in the vicinity thereof.

According to the above described optical apparatus, the amount of flection of the connection portion can be reduced so that the space for absorbing the flection can be extremely small, and further, the stress imposed on the connection portion 24 can be made extremely small. Consequently, a small-size and highly reliable camera shake compensation mechanism or an optical apparatus having the camera shake compensation mechanism is obtained.

Moreover, since a sensor can be mounted on the connection portion that connects the board where the image sensor is mounted and another board, a low-cost and small-size optical apparatus having a camera shake compensation function can be provided.

### BRIEF DESCRIPTION OF THE DRAWINGS

These and other objects and features of the present invention will become clear from the following description taken in conjunction with the preferred embodiments thereof with reference to the accompanying drawings, in which:

FIG. 1 is an external view of an optical apparatus according to the present invention;

FIGS. 2(a) to 2(c) are cross-sectional views showing the structure of the optical apparatus according to the present invention;

FIGS. 3(a) to 3(c) are conceptual views explaining the movement of the lens barrel in the camera shake compensation of the optical apparatus according to the present invention;

FIGS. 4(a) to 4(c) are explanatory views explaining the condition where a connection portion of the optical apparatus according to the present invention is moved; and

FIGS. 5(a) to 5(c) are explanatory views explaining the condition where a connection portion of an optical apparatus using the prior art is moved.

### DETAILED DESCRIPTION OF THE PREFERRED EMBODIMENTS

Hereinafter, an embodiment of the present invention will be described with reference to the drawings.

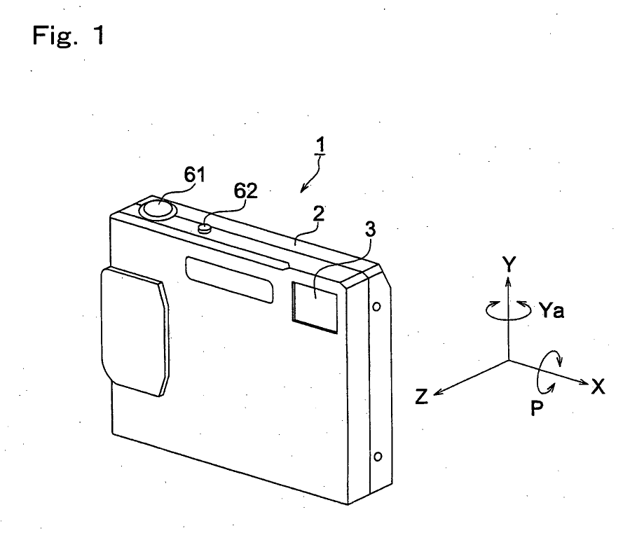

FIG. 1 is an external perspective view schematically showing the structure of a digital camera 1 according to an embodiment of the optical apparatus of the present invention.

On the top surface of a camera body 2, a shutter button 61 and a power switch 62 are provided. On the front surface of the camera body 2, a taking optical system 3 is provided.

The digital camera 1 has a camera shake compensation function that compensates for (suppresses) the blur of the subject image in the image due to a camera shake. In the description that follows, the directions and orientations are represented by using the XYZ three-dimensional rectangular coordinate system shown in FIG. 1. Here, the direction of the Z axis is a direction along the optical axis L of the taking optical system 3, and the positive direction of the Z axis is a direction that is the origin of incidence of the incident light (toward the lower left in the figure). Moreover, the direction of the Y axis is the vertical direction, and the positive direction of the Y axis is upward in the vertical direction (upward in the figure). Further, the direction of the X axis is a rightward direction in the figure, and the positive direction of the X axis is rightward in the figure.

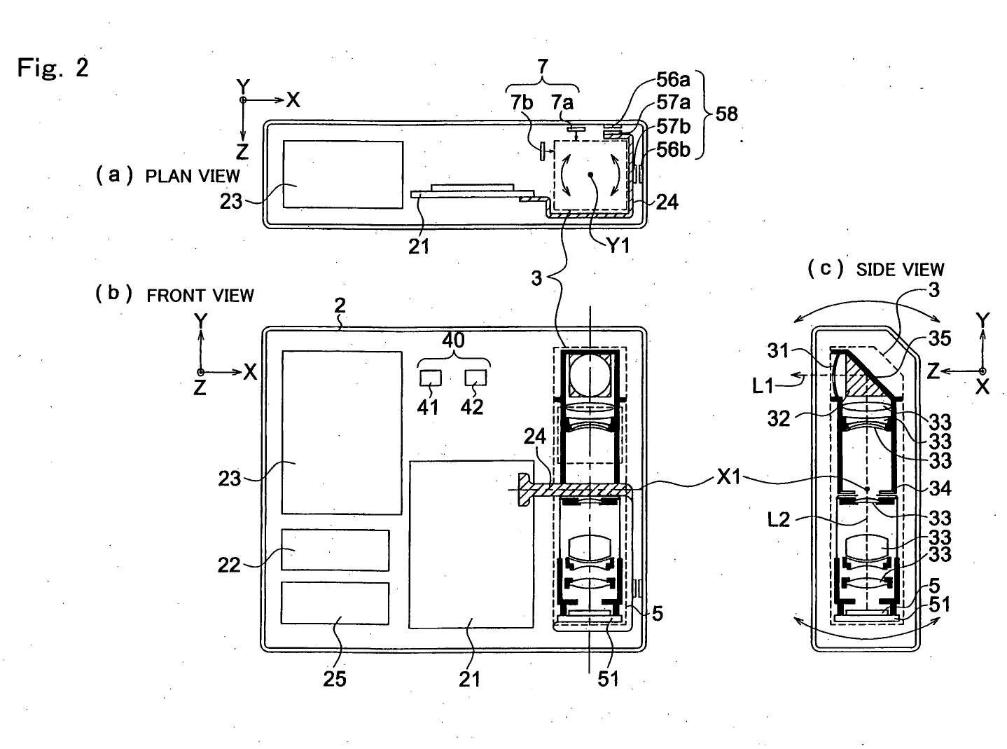

The internal structure of the digital camera 1 shown in FIG. 1 will be described with reference to FIGS. 2(a) to 2(c). FIG. 2(a) is a plan view of the digital camera 1 of FIG. 1 viewed from the Y direction. FIG. 2 (b) is a front view viewed from the Z direction of FIG. 1. FIG. 2(c) is a side view viewed from the X direction of FIG. 1.

The digital camera 1 mainly comprises the camera body 2 and the taking optical system 3 held by the camera body 2. While in the embodiment of the present invention, a taking optical system using a bending optical system suitable for size reduction is described as the optical apparatus, the present invention is not limited to the taking optical system using a bending optical system.

The taking optical system 3 using a bending optical system mainly comprises a lens barrel 35, and a front lens 31, a prism 32, a plurality of lens units 33 and a diaphragm 34 provided in the lens barrel 35. In the bending optical system, the optical axis L1 of the front lens 31 directed toward the front of the camera body 2 is perpendicularly bent toward the bottom of the camera body 2 (the negative direction of the Y axis) by the prism 32 that functions as optical axis bending means, and becomes the optical axis L2 of the plurality of lens units 33. The light incident on the front lens 31 is reflected at the prism 32, passes through the plurality of lens units 33, and is formed into an image on a CCD (charge-coupled device) 5 being an example of the image sensor which CCD is mounted on a CCD board 51 being a first circuit board fixed to the other end of the lens barrel 35. In the present invention, the image sensor may be a solid-state image sensor such as a CMOS sensor or a CID sensor instead of the CCD.

The taking optical system 3 is formed as a zoom lens system, and the focal length (photographing magnification) thereof can be changed by changing the arrangement of the lens units 33.

The CCD 5 is an image sensor comprising minute pixels each provided with a color filter, and photoelectrically converts the light image of the subject (subject image) formed by the taking optical system 3 into image signals having color components of, for example, R, G and B. The light receiving surface of the CCD 5 is disposed so as to coincide with the image forming plane, and a partial area of the image forming plane including the image circle is obtained as image data (in this specification, referred to merely as “image” as appropriate)

The CCD board 51 comprises a rigid-flexible board where a rigid board and a flexible board are integrally formed, or a multilayer FPC. The CCD 5 is mounted on the flexible board by thermocompression bonding, and a control circuit that drives the CCD is mounted on the rigid board. A connection portion 24 comprises a belt-shaped flexible board, and is connected to the rigid board constituting the CCD board 51 by thermocompression bonding. One end of the connection portion 24 is connected to a main board 21 being a second board. The connection portion 24 and the main board 21 may be connected either by thermocompression bonding or by a connector.

A power source portion 22 receives power from a battery 23 and supplies it to the main board 21 and the like. The CCD board 51 operates by receiving the power and a synchronous clock supplied from the main board 21 through the connection portion 24, and outputs the video signals of the CCD 5 to the main board 21 through the connection portion 24. At the main board 21, the video signals obtained by the CCD 5 are converted into digital signals, undergo image processings, and are recorded onto a memory card 25.

Next, the camera shake compensation mechanism of the digital camera 1 will be described.

The lens barrel 35 is held so as to be swingable about a swing rotation axis Y1 (the direction of the Y axis in the figure) and a swing rotation axis X1 (the direction of the X axis in the figure) by a holding mechanism provided in the camera body 2, and can be swung about these axes by an actuator 7 being swinging means within a range necessary for camera shake compensation.

The actuator 7 which is formed, for example, by use of a moving coil swiftly responds to shakes applied to the camera body 2, and moves the lens barrel 35 in the directions of the X and Y axes. The actuator 7 comprises a first direction actuator 7a that supplies a swinging force in the direction of the X axis and a second direction actuator 7b that supplies a swinging force in the direction of the Y axis.

In the lens barrel 35 and the camera body 2, a position sensor 58 for detecting the position of the lens barrel 35 being moved is disposed. The position sensor 58 is provided with two light projecting portions 56a and 56b comprising photoelectric diodes or the like and two light receiving portions 57a and 57b comprising photodiodes or the like. The light receiving portion 57a is fixed to the lower rear surface side of the lens barrel 35 (the negative direction of the Y axis and the negative direction of the Z axis) and the light receiving portion 57b is fixed to the lower right side surface side of the lens barrel 35 (the negative direction of the Y axis and the positive direction of the X axis), whereas the light projecting portions 56a and 56b are fixed to the inside of the housing of the camera body 2 so as to be opposed to the light receiving portions 57a and 57b. Specifically, the two light receiving portions 57a and 57b are mounted on the connection portion 24, and fixed to the lens barrel 35 by mounting holes provided in the vicinity of the light receiving portions 57a and 57b on the connection portion 24. The light projecting portions 56a and 56b are attached to the rigid or the flexible board, and fixed to mounting holes provided in the housing of the camera body 2.

The light receiving portions 57a and 57b are connected to a photocurrent amplifying circuit on the main board 21 by the connection portion 24, so that an output voltage corresponding to the quantity of received light is obtained. The light projected by the light projecting portions 56a and 56b can be received by the light receiving portions 57a and 57b, and based on the change in the position of the light received by the light receiving portions 57a and 57b, the position of the lens barrel 35 is obtained as an XY coordinate position. Specifically, the position of the lens barrel 35 in the direction of the X axis is detected by the first light projecting portion 56a and the first light receiving portion 57a, and the position of the lens barrel 35 in the direction of the Y axis is detected by the second light projecting portion 56b and the second light receiving portion 57b.

In the camera body 2, a shake sensor 40 that detects a shake of the taking optical system 3 due to a camera shake is provided. The shake sensor 40 is provided with two angular velocity sensors (a first angular velocity sensor 41 and a second angular velocity sensor 42). The angular velocity of a rotatory shake (pitching) P about the X axis is detected by the first angular velocity sensor 41, and the angular velocity of a rotatory shake (yawing) Ya about the Y axis is detected by the second angular velocity sensor 42. The lens barrel 35 is rotated in the directions of the X and Y axes by the actuator 7 based on the two angular velocities detected by the shake sensor 40, whereby compensation of the blur of the subject image in the image, that is, camera shake compensation is performed. When the compensation range of the blur angle due to a camera shake is ±0.4 degree both in pitching and yawing as an example, sufficient camera shake compensation effect is obtained under normal photographing conditions. As described above, the actuator 7, the position sensor 58 and the shake sensor 40 function as the camera shake compensation means in cooperation with one another.

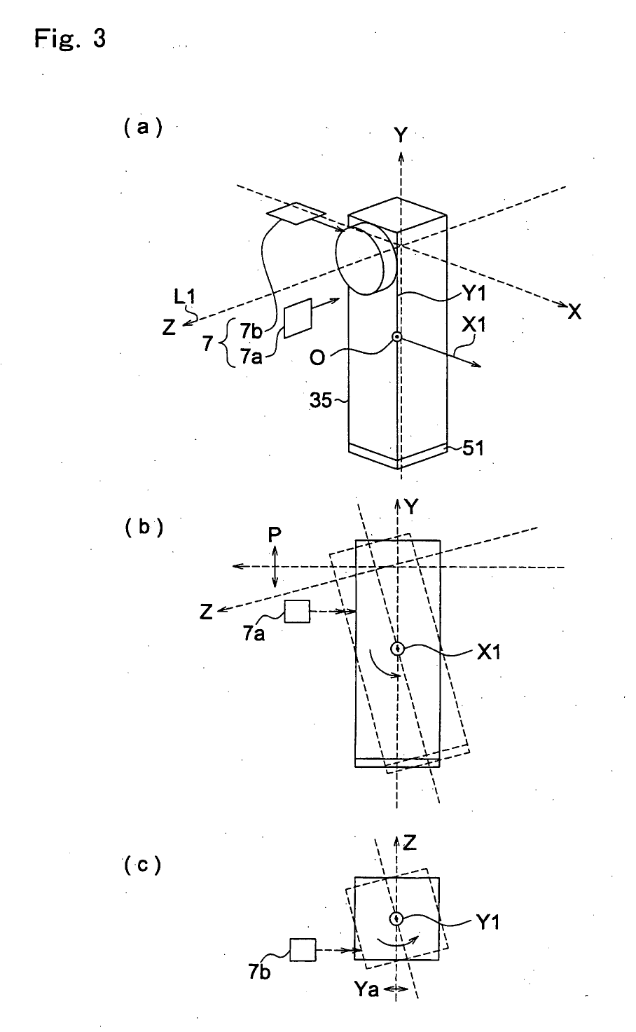

The movement of the lens barrel 35 in the camera shake compensation of the digital camera 1 of FIG. 1 will be described with reference to FIGS. 3(a) to 3(c). FIGS. 3(a) to 3(c) are conceptual views explaining the movement of the lens barrel 35, and express only the main structure of the camera shake compensation around the lens barrel 35. The elements the same as those shown in FIGS. 2(a) to 2(c) are denoted by the same reference numerals, and description thereof is omitted.

FIG. 3(a) is a perspective view explaining the movement of the lens barrel 35. By being supplied with a swinging force in the direction of the X axis by the first direction actuator 7a, the lens barrel 35 is swung about the swing rotation axis X1. Moreover, by being supplied with a swinging force in the direction of the Y axis by the second direction actuator 7b, the lens barrel 35 is swung about the swing rotation axis Y1. The point of intersection O is a point of intersection of the swing rotation axis X1 and the swing rotation axis Y1.

FIG. 3 (b) is a side view of the lens barrel 35 viewed from the direction of the X axis. In FIG. 3(b), the condition where the lens barrel 35 is rotated about the X1 axis by the first direction actuator 7a is shown by the dotted lines. When the lens barrel 35 is rotated about the X1 axis, the optical axis L1 is moved in the pitch direction (shown by the arrow P), whereby the shake in the pitch direction can be compensated for.

FIG. 3 (c) is a side view of the lens barrel 35 viewed from the direction of the Y axis. Likewise, in FIG. 3(c), the condition where the lens barrel 35 is rotated about the Y1 axis by the second direction actuator 7b is shown by the dotted lines. When the lens barrel 35 is rotated about the Y1 axis, the optical axis L1 is moved in the yaw direction (shown by the arrow Ya), whereby the shake in the yaw direction can be compensated for.

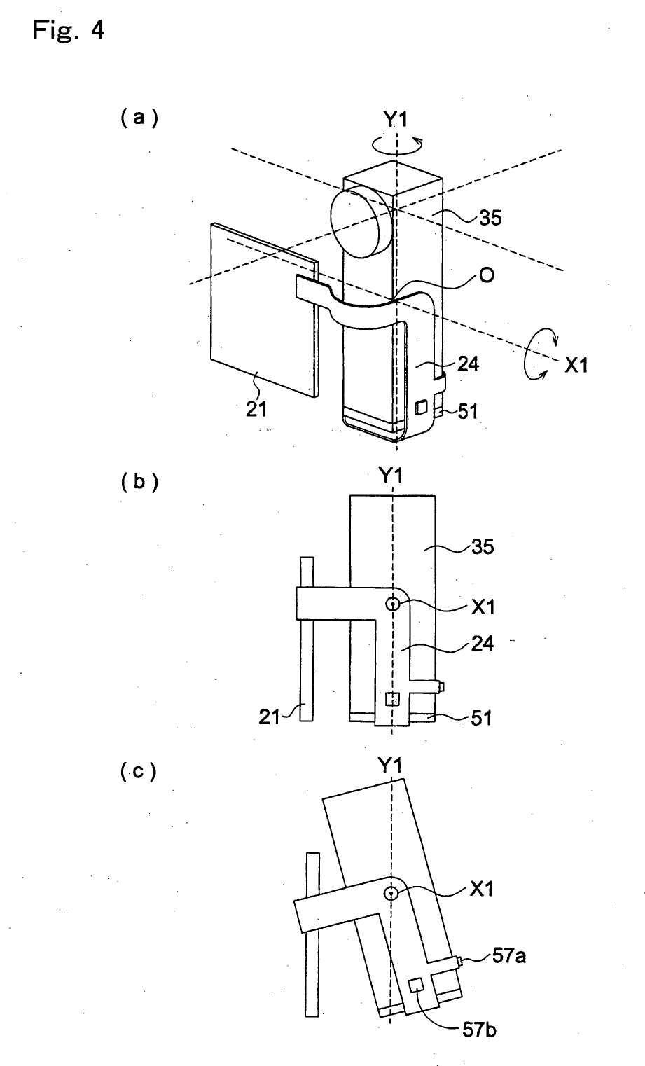

Next, the condition where the connection portion 24 is moved as the lens barrel 35 of the digital camera 1 according to the present invention is moved will be described with reference to FIGS. 4(a) to 4(c).

FIG. 4(a) is a perspective view explaining the disposition of the connection portion 24 of the present invention.

The connection portion 24 derived from the CCD board 51 is disposed along the swing rotation axis Y1 with the outer side of the lens barrel 35 toward the point of intersection O. The connection portion 24 is bent in the vicinity of the point of intersection O toward the main board 21 along the swing rotation axis X1 as shown in FIG. 4 (a) so that it can be connected to the main board 21.

FIGS. 4(b) and 4(c) are side views, viewed from the direction of the X axis, of the disposition of the lens barrel 35, the connection portion 24 and the main board 21 according to the present invention. FIG. 4(b) is a view explaining the condition of the connection portion 24 in a normal state where camera shake compensation is not performed. FIG. 4(c) is a view explaining the condition of the connection portion 24 under a condition where the lens barrel 35 is rotated about the X1 axis. Since the connection portion 24 is rotated about the vicinity of the point of intersection O, the overall movement amount thereof is small, so that the amount of flection for absorbing the movement necessary at the connection with the main board 21 can be reduced.

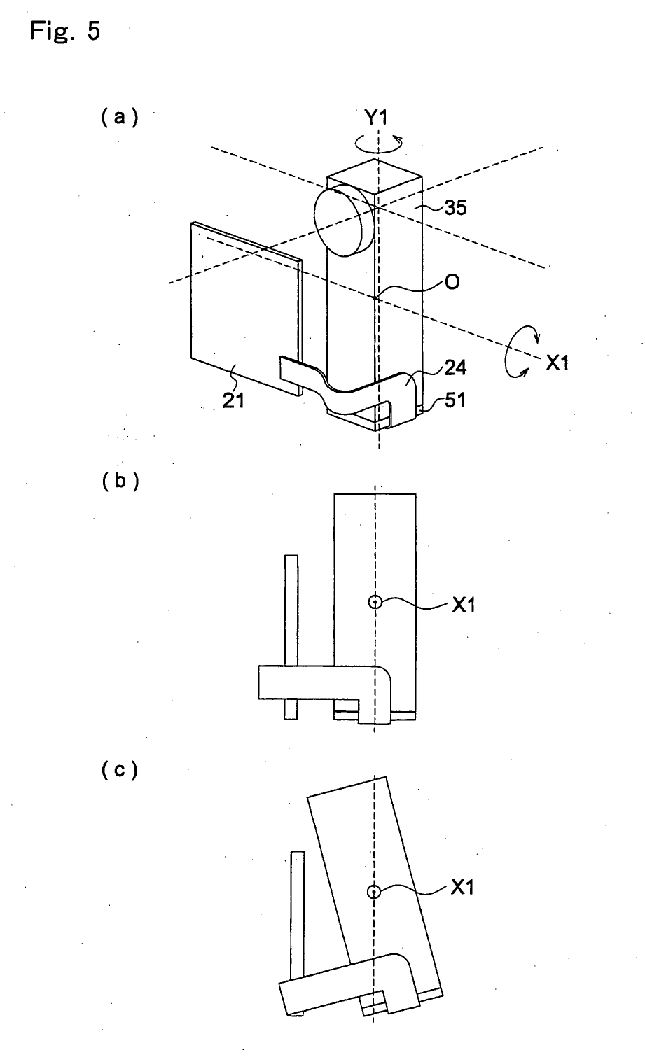

Now, to clearly show the effect of the present invention, the movement of the connection portion when the connection portion 24 is disposed in a position apart from the point of intersection O of the two swing rotation axes will be described with reference to FIGS. 5(a) to 5(c).

FIG. 5 (a) is a perspective view explaining an example where the connection portion 24 is disposed so as not to be along the vicinity of the point of intersection O. The connection portion 24 disposed in the direction of the Y axis from the CCD board 51 does not extend to the point of intersection O but is immediately bent toward the main board 21 in parallel to the swing rotation axis X1 so that it can be connected to the main board 21.

FIGS. 5(b) and 5(c) are side views, viewed from the direction of the X axis, of the lens barrel 35, the connection portion 24 and the main board 21 of FIG. 5 (a). FIG. 5 (b) is a view explaining the condition of the connection portion 24 in a normal state where camera shake compensation is not performed. FIG. 5(c) is a view explaining the condition of the connection portion 24 under a condition where the lens barrel 35 is rotated about the X1 axis. In this disposition, since the connection portion 24 is rotated in a position apart from the point of intersection O as shown in FIG. 5(c), the movement amount thereof is large and it is necessary that the amount of flection for absorbing the movement be large. Consequently, it is necessary that the space for accommodating the flection of the connection portion 24 be large between the camera body 2 and the lens barrel 35, which is an obstacle to mounting in a small size.

As described above, according to the present embodiment, the amount of flection of the connection portion can be reduced so that the space for absorbing the flection can be extremely small, and further, the stress imposed on the connection portion 24 can be made extremely small. Consequently, a small-size and highly reliable camera shake compensation mechanism or an optical apparatus having the camera shake compensation mechanism is obtained.

Moreover, since a sensor can be mounted on the connection portion that connects the board where the image sensor is mounted and another board, a low-cost and small-size optical apparatus having a camera shake compensation function can be provided.

While a digital camera is illustrated as the present embodiment, the present invention is similarly applicable to mobile telephones and video cameras. In short, the present invention is applicable to anything that has a mechanism performing camera shake compensation by biaxially swinging the lens barrel.

As described above, the optical apparatus of the present invention comprises: a body; a lens barrel provided in the body; a camera shake compensation mechanism that swings the lens barrel about two different rotation axes; and a connection portion for connecting the body and the lens barrel which connection portion is partly fixed to the lens barrel and disposed along the point of intersection of the two rotation axes of the lens barrel or an area formed in the vicinity thereof. By this, the amount of flection of the connection portion can be reduced so that the space for absorbing the flection can be extremely small, and further, the stress imposed on the connection portion can be made extremely small. Consequently, an optical apparatus having a small-size and highly reliable camera shake compensation mechanism is obtained.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. An optical apparatus comprising:
a body;
a lens barrel provided in the body;
a camera shake compensation mechanism that swings the lens barrel about two different rotation axes; and
a connection portion for connecting the body and the lens barrel which is partly fixed to the lens barrel and disposed along the point of intersection of the two rotation axes of the lens barrel or an area formed in the vicinity thereof.

2. An optical apparatus as claimed in claim 1, further comprising:
a circuit board is provided that is fixed to one end of the lens barrel and connected to the body through the connection portion,
wherein the connection portion is disposed along the optical axis of the lens barrel from the circuit board and is set so as to be bent at the point of intersection of the two rotation axes of the lens barrel or in the vicinity thereof.

3. An optical apparatus as claimed in claim 1, wherein the connection portion is a flexible board.

4. An optical apparatus as claimed in claim 2, wherein an image sensor that converts a subject image incident on the lens barrel into an electric signal is disposed on the circuit board.

5. An optical apparatus as claimed in claim 1, wherein the connection portion has a position sensor that detects the relative position of the lens barrel to the body.

6. An optical apparatus as claimed in claim 1, wherein the position sensor comprises a pair of transmitting and receiving portions provided on the body and the connection portion.

7. An optical apparatus as claimed in claim 1, wherein the lens barrel has a bending optical system that bends incident light.

8. A camera shake compensation device comprising:
a lens barrel for compensating camera shake by swinging the lens barrel about two rotation axes can be performed; and
a connection portion for connecting a external portion and the lens barrel which is partly fixed to the lens barrel and disposed along the point of intersection of the two rotation axes of the lens barrel or an area formed in the vicinity thereof.

9. A camera shake compensation device as claimed in claim 8, further comprising:
a circuit board is provided that is fixed to one end of the lens barrel and connected to the connection portion,
wherein the connection portion is disposed along the optical axis of the lens barrel from the circuit board and is set so as to be bent at the point of intersection of the two rotation axes of the lens barrel or in the vicinity thereof.

10. A camera shake compensation device as claimed in claim 8, wherein the connection portion is a flexible board.

11. A camera shake compensation device as claimed in claim 9, wherein an image sensor that converts a subject image incident on the lens barrel into an electric signal is disposed on the circuit board.

12. A camera shake compensation device as claimed in claim 8, wherein the connection portion has a position sensor that detects the relative position of the lens barrel to the external portion.

13. A camera shake compensation device as claimed in claim 8, wherein the position sensor comprises a pair of transmitting and receiving portions provided on the external portion and the connection portion.

14. A camera shake compensation device as claimed in claim 8, wherein the lens barrel has a bending optical system that bends incident light.
